(19) United States
(12) Patent Application Publication
(10) Pub. No.: US 2019/0266531 A1
(43) Pub. Date: Aug. 29, 2019

(54) VEHICLE MANAGEMENT DEVICE AND VEHICLE MANAGEMENT METHOD

(71) Applicant: Toyota Jidosha Kabushiki Kaisha, Toyota-shi Aichi-ken (JP)

(72) Inventors: Kazuhiro Umeda, Nisshin-shi Aichi-ken (JP); Takumi Fukunaga, Nisshin-shi Aichi-ken (JP); Makoto Akahane, Nagoya-shi Aichi-ken (JP); Satoshi Usui, Machida-shi Tokyo (JP)

(73) Assignee: Toyota Jidosha Kabushiki Kaisha, Toyota-shi Aichi-ken (JP)

(21) Appl. No.: 16/280,392

(22) Filed: Feb. 20, 2019

(30) Foreign Application Priority Data
Feb. 26, 2018 (JP) 2018-032301

(51) Int. Cl. G06Q 10/06; G06Q 30/06

(52) U.S. Cl. CPC G06Q 10/06312; G06Q 30/0645

(57) ABSTRACT

A vehicle management device including a processor configured to permit a first user belonging to a first user group to use a vehicle available for car sharing services within a range of an assigned number of vehicles preferentially assigned to the first user group that is set in advance at least for a predetermined day of a week and time range, and permit a second user belonging to a second user group to use a remaining number of vehicles excluding the assigned number of vehicles from a total number of vehicles available for the car sharing services.

### CROSS-REFERENCE TO RELATED APPLICATIONS

This application claims priority to Japanese Patent Application No. 2018-032301 filed on Feb. 26, 2018, which is incorporated herein by reference in its entirety including the specification, drawings and abstract.

### BACKGROUND

### 1. Technical Field

The disclosure relates to a vehicle management device and a vehicle management method.

### 2. Description of Related Art

Japanese Patent Application Publication No. 2013-54537 (JP 2013-54537 A) describes a vehicle management system that, when a user makes a reservation to use a vehicle available for car sharing services, refers to past use characteristic information of the user and suggests the user to change the reservation to a date and time where the vehicle is available and the user is allowed to use the car sharing services at a lower fee than normal.

### SUMMARY

In JP 2013-54537 A, the vehicle management system suggests the user to change the reservation to a different date and time where a fee is relatively low and a reservation rate of the vehicle is low. In many cases, however, the user makes a reservation after deciding the date and time for using the vehicle. Thus, even when a change of the date and time is suggested to such a user, the user is unlikely to accept the suggestion, making it difficult to improve a use rate of the vehicle.

The disclosure provides a vehicle management device and a vehicle management method that can improve the use rate of vehicles available for car sharing services.

The vehicle management device according to a first aspect of the disclosure includes a processor configured to permit a first user belonging to a first user group to use a vehicle available for car sharing services within a range of an assigned number of vehicles preferentially assigned to the first user group that is able to be set in advance at least for a predetermined day of a week and a predetermined time range, and permit a second user belonging to a second user group to use a remaining number of vehicles excluding the assigned number of vehicles from a total number of vehicles available for the car sharing services.

In the aspect described above, the processor may be configured to calculate for a predetermined rental area, based on vehicle use record information of the second user, a transition in the number of non-operating vehicles which are vehicles not used, create groups of the days of the week and of the time ranges where transition trends in the number of non-operating vehicles are similar to each other for the rental area based on the calculated transition in the number of non-operating vehicles, and set the assigned number of vehicles based on the transition in the number of non-operating vehicles for the grouped days of the week and the grouped time ranges.

In the aspect described above, the processor may be configured to set the smallest number of vehicles, out of the number of non-operating vehicles transitioning in combination of the grouped days of the week and the grouped time ranges, as the assigned number of vehicles.

In the aspect described above, the first user group may be a corporation and the processor may be configured to divide the assigned number of vehicles and set the divided number of vehicles for each corporation when there is a plurality of corporations.

In the aspect described above, the processor may be configured to further set a discount rate of a use fee for the first group, and the discount rate may be set to increase as a rate of the number of non-operating vehicles with respect to the total number of vehicles increases.

In the aspect described above, the processor may be configured to permit the first user to use an extra number of vehicles exceeding the assigned number of vehicles, the extra number of vehicles being within a range of the number of vehicles that is allowed to be used by the second user.

The vehicle management method according to a second aspect of the disclosure is executed by a processor and includes permitting a first user belonging to a first user group to use a vehicle available for car sharing services within a range of an assigned number of vehicles preferentially assigned to the first user group that is able to be set in advance at least for a predetermined day of a week and time range, and permitting a second user belonging to a second user group to use the number of vehicles excluding the assigned number of vehicles from a total number of vehicles available for the car sharing services.

According to the aspects of the disclosure, the vehicle management device and the vehicle management method that can improve the use rate of vehicles available for car sharing services can be provided.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of a configuration of a vehicle management system including a server according to an embodiment;

FIG. 2 is a flowchart describing an example of an operation of the server shown in FIG. 1; and

FIG. 3 is a flowchart describing an example of an operation of the server shown in FIG. 1.

### DETAILED DESCRIPTION OF EMBODIMENTS

Embodiments of the present disclosure will be described below with reference to the accompanying drawings. In the respective drawings, units denoted with the same reference numerals have the same or similar configuration.

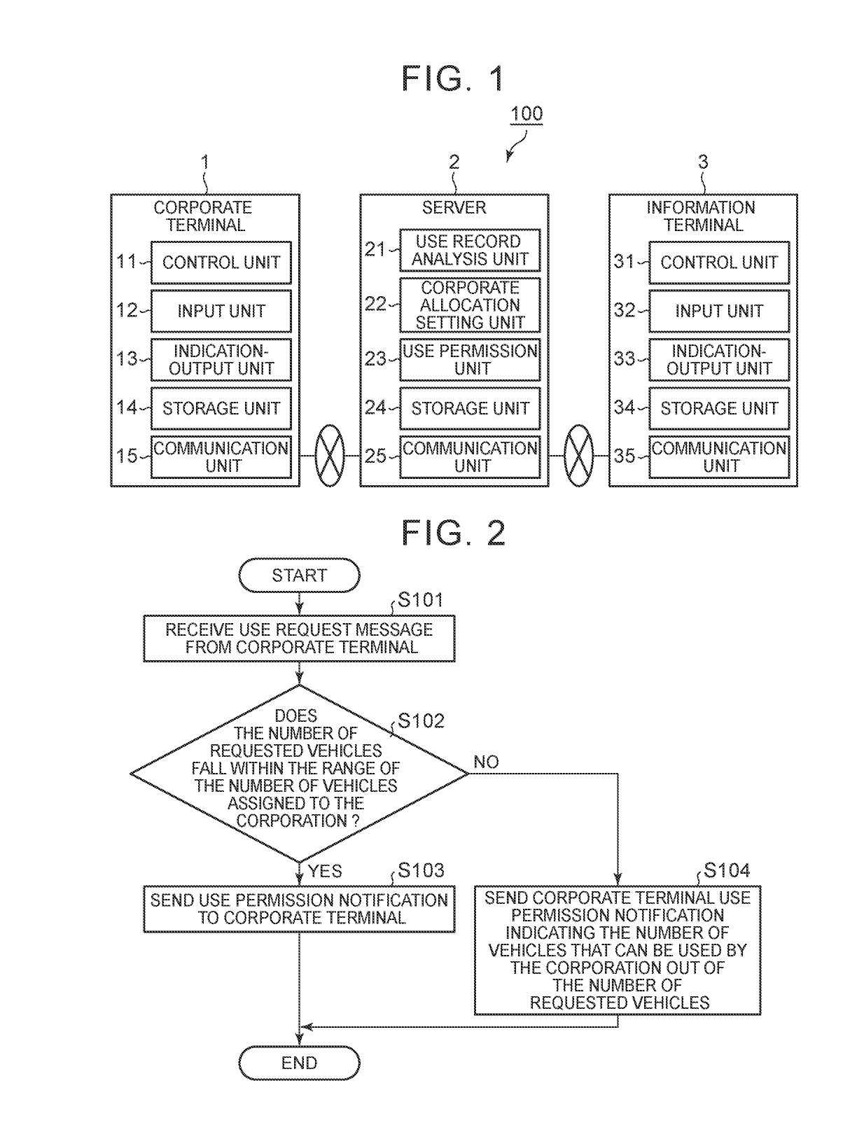

A configuration of a vehicle management system including a server (vehicle management device) according to an embodiment will be described with reference to FIG. 1. A vehicle management system 100 includes, for example, a corporate terminal 1 used by an operator of a corporation using car sharing services, a server 2 managing information related to a vehicle available for the car sharing services, and an information terminal 3 kept by a user using the car sharing services.

Users using the car sharing services include corporate (first user group) users (first users) and individual (second user group) users (second users). Hereinafter, when referring to either one of the corporate users and individual users without distinction, they are indicated as users.

The corporate terminal 1 and the server 2 are configured to be communicable with each other via a network. The information terminal 3 and the server 2 are configured to be communicable with each other via a network. The network may be either wired or wireless, or may be a combination thereof.

The corporate terminal 1 is a terminal device such as a personal computer (PC). The corporate terminal 1 is not limited to a PC. Other terminal devices, such as a laptop computer, a tablet terminal, a smartphone, a cellular phone, and a portable digital assistant (PDA) may be used appropriately as the corporate terminal 1.

The corporate terminal 1 includes, for example, a control unit 11, an input unit 12, an indication-output unit 13, a storage unit 14, and a communication unit 15 as a functional configuration. The corporate terminal 1 includes, for example, a controller including a central processing unit (CPU) and a memory, an operation device, a display, a speaker, a storage device, and a communication device as a physical configuration. Respective functions of the control unit 11, the input unit 12, the indication-output unit 13, the storage unit 14, and the communication unit 15 are realized by the CPU executing a predetermined program stored in the memory.

The information terminal 3 is a terminal device such as a smartphone. The information terminal 3 is not limited to a smartphone. Other terminal devices, such as a tablet terminal, a cellular phone, a PDA, and a laptop computer may be used appropriately as the information terminal 3.

The information terminal 3 includes, for example, a control unit 31, an input unit 32, an indication-output unit 33, a storage unit 34, and a communication unit 35 as a functional configuration. The information terminal 3 includes, for example, a controller including a CPU and a memory, an operation device, a display, a speaker, a storage device, and a communication device as a physical configuration. Respective functions of the control unit 31, the input unit 32, the indication-output unit 33, the storage unit 34, and the communication unit 35 are realized by the CPU executing a predetermined program stored in the memory.

The server 2 includes, for example, a use record analysis unit 21, a corporate allocation setting unit (setting unit) 22, a use permission unit 23, a storage unit 24, and a communication unit 25 as a functional configuration. The server 2 includes, for example, a controller including a CPU and a memory, a storage device, and a communication device as a physical configuration. Respective functions of the use record analysis unit 21, the corporate allocation setting unit 22, the use permission unit 23, the storage unit 24, and the communication unit 25 are realized by the CPU executing a predetermined program stored in the memory.

The server 2 stores and manages use record information corresponding to respective vehicles available for car sharing services via a database, for example. The use record information includes, for example, a vehicle ID that identifies the vehicle and use information of the vehicle. The use information includes, for example, a user ID that identifies the user using the vehicle, a user category, a use start time, a use start place, a scheduled return time, and a scheduled return place. The user category is a category that identifies whether the user is a corporate user or an individual user.

The use information of the vehicle can be collected as needed from an on-board device mounted on respective vehicles and the information terminal 3 kept by the user using respective vehicles, for example. A part of or all of the use information may be collected as needed from a server of a data center that manages information including information of the on-board device.

The use record analysis unit 21, the corporate allocation setting unit 22, and the use permission unit 23 of the functions of server 2 are described in detail below.

### Use Record Analysis Unit 21

The use record analysis unit 21 calculates transitions in the number of vehicles that are not used by users (hereinafter referred to as “non-operating vehicles”) for each predetermined rental area based on the use record information of the individual users.

The predetermined rental area is an area defined by classifying, as desired, areas where the car sharing services are provided. For example, the areas can be classified by parking lots, or desired regions such as districts, towns, and cities including a plurality of parking lots. Specifically, the areas can be classified by “a parking lot in 1-Chome, Sakae Naka-ku, Nagoya City”, “the Sakae area in Naka-ku, Nagoya City”, or “an area surrounding Nagoya Station (within a radius of 300 m)”. In cases such as when the scale of the car sharing services is small, the transitions in the number of non-operating vehicles may be calculated subject to all areas without classifying the area where the car sharing services are provided by rental areas.

The use record analysis unit 21 creates groups of days of the week and of time ranges where the transition trends in the number of non-operating vehicles are similar to each other for the rental area based on the transitions in the number of non-operating vehicles.

The day of the week is grouped by weekdays and by weekends and holidays, for example. The time range is grouped by commuting time range (from 6 a.m. to 9 am. and from 5 p.m. to 7 p.m., etc.), by daytime (from 9 a.m. to 5 p.m., etc.), by evening (from 7 p.m. to 10 p.m., etc.) and by early morning and late evening (from 10 p.m. to 6 a.m. next morning, etc.), for example.

### Corporate Allocation Setting Unit 22

The corporate allocation setting unit 22 sets the number of vehicles to be preferentially assigned to corporations (hereinafter referred to as “a number of vehicles assigned to corporations (assigned number of vehicles)”) based on past transitions in the number of non-operating vehicles for the grouped day of the week and the grouped time range. For example, the corporate allocation setting unit 22 may set the smallest number of vehicles, out of the number of non-operating vehicles transitioning in combination of the day of the week and the time range, as the number of vehicles assigned to corporations. The following describes the above in detail.

For example, when the number of non-operating vehicles in the area surrounding Nagoya Station during the commuting time range on weekdays transitions between 2 and 4, and when the number of non-operating vehicles in the area surrounding Nagoya Station during the daytime on weekdays transitions between 30 and 45, the number of vehicles assigned to corporations in the area surrounding Nagoya Station during the commuting time range on weekdays is set to 2, whereas the number of vehicles assigned to corporations in the area surrounding Nagoya Station during the daytime on weekdays is set to 30.

Here, for example, when concluding a monthly or a yearly contract on vehicle use with a corporation, the number of vehicles under the contract with the corporation is set to fall within the range of the number of vehicles assigned to corporations set for the day of the week and the time range. For example, when the number of vehicles assigned to corporations during the daytime on weekdays is set to 30 in the area surrounding Nagoya Station, the corporation may conclude a contract to use up to 30 vehicles during the daytime on weekdays in the area surrounding Nagoya Station. In this case, during the contract period, the corporation may be charged with a use fee for the number of contracted vehicles during the daytime on weekdays, regardless of the actual number of vehicles used by the corporation.

When there is a plurality of corporations with which a contract is concluded, the sum of the number of vehicles under the contract with each corporation is set to fall within the range of the number of vehicles assigned to corporations set for the day of the week and the time range. In other words, the number of vehicles assigned to corporations is divided and the divided number of vehicles is distributed to the plurality of corporations. The following example indicates the case where two corporations each conclude a use contract and the number of vehicles assigned to corporations during the daytime on weekdays in the area surrounding Nagoya Station is 30. When a first corporation concludes a contract to use 20 vehicles during the daytime on weekdays in the area surrounding Nagoya Station, a second corporation can conclude a contract to use up to 10 vehicles during the daytime on weekdays in the area surrounding Nagoya Station.

In addition to setting the number of vehicles assigned to corporations described above, the corporate allocation setting unit 22 may set the discount rate of the use fee for corporations. In some embodiments, the discount rate is set to increase as the rate of the number of non-operating vehicles increases. For example, provided that a total of 100 vehicles are available for the car sharing services in the area surrounding Nagoya Station, the discount rate for using the services when the number of non-operating vehicles is 10 to 19 may be set to 3%, the discount rate for using the services when the number of non-operating vehicles is 20 to 39 may be set to 8%, and the discount rate for using the services when the number of non-operating vehicles is 40 or more may be set to 10%.

### Use Permission Unit 23

The use permission unit (first use permission unit) 23 permits corporations to use the vehicle available for car sharing services within the range of the number of vehicles assigned to corporations. For example, when the number of vehicles assigned to corporations during the daytime on weekdays is set to 30 in the area surrounding Nagoya Station, the corporation is permitted to use up to 30 vehicles during the daytime on weekdays in the area surrounding Nagoya Station.

The use permission unit (second use permission unit) 23 permits individual users to use the number of vehicles excluding the number of vehicles assigned to corporations. For example, in the case where 100 vehicles are available in the area surrounding Nagoya Station and the number of vehicles assigned to corporations during the daytime on weekdays is set to 30, the individual users are permitted to use up to the remaining 70 vehicles during the daytime on weekdays in the area surrounding Nagoya Station.

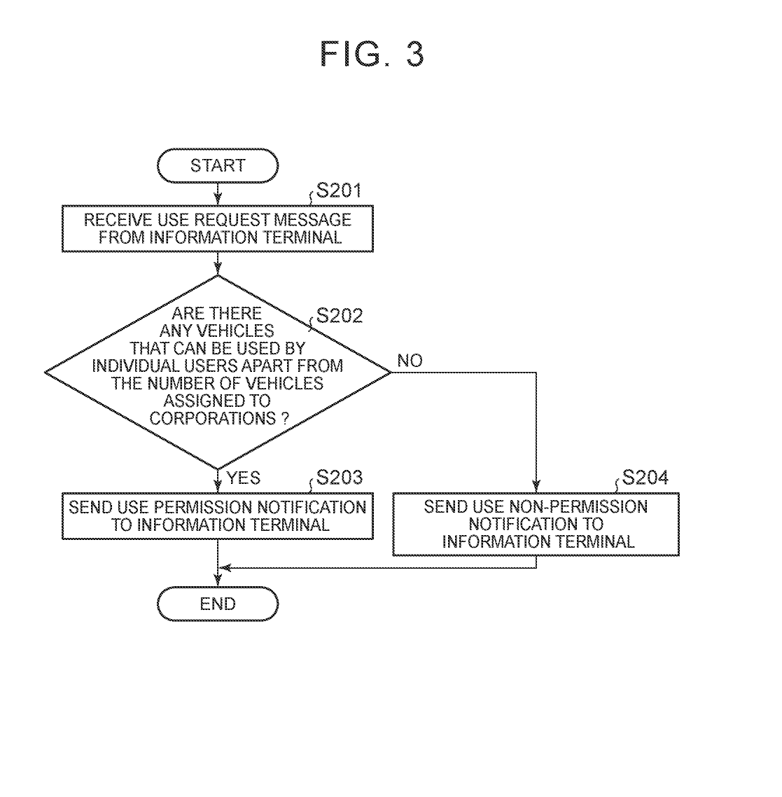

Next, an example of an operation of the vehicle management system 100 according to the embodiment will be described with reference to FIGS. 2 and 3. FIG. 2 is an example of an operation of the server 2 in the case where the server 2 receives a vehicle use request message from the corporate terminal 1.

First, when the operator of the corporation operates the corporate terminal 1 to designate, for example, the date and time, the number of vehicles, and the rental area of the use request and confirms the use request, the use request message sent from the corporate terminal 1 is received by the server 2 (step S101).

Subsequently, based on the use request message, the use permission unit 23 of the server 2 refers to the number of vehicles assigned to corporations set for the day of the week and the time range in the rental area of the use request to determine whether the number of requested vehicles falls within the range of the number of vehicles assigned to the relevant corporation (step S102). When the use permission unit 23 of the server 2 determines YES (step S102: YES), the use permission unit 23 of the server 2 sends a use permission notification to the corporate terminal 1 (step S103). The operation is thus completed.

In contrast, when the use permission unit 23 of the server 2 determines NO in step S102 (step S102: NO), the use permission unit 23 of the server 2 sends the corporate terminal 1 a use permission notification indicating the number of vehicles that can be used by the corporation out of the number of requested vehicles in the rental area and in the date and time of the use request included in the use request message (step S104). The operation is thus completed.

The number of vehicles that can be used by the corporation may be determined based on the number of vehicles assigned to the relevant corporation and the number of vehicles that can be used by the individual users (vehicles that have not been reserved by the individual users). That is, the use permission unit 23 can permit the corporate users to use an extra number of vehicles exceeding the number of vehicles assigned to the corporations, the extra number of vehicles being within the range of the number of vehicles that can be used by the individual users.

FIG. 3 is an example of an operation of the server 2 in the case where the server 2 receives a vehicle use request message from the information terminal 3.

First, when the individual user operates the information terminal 3 to designate, for example, the date and time and the rental area of the use request and confirms the use request, the use request message sent from the information terminal 3 is received by the server 2 (step S201).

Subsequently, based on the use request message, the use permission unit 23 of the server 2 refers to the number of vehicles assigned to corporations set for the day of the week and the time range in the rental area of the use request to determine whether any vehicles can be used by the individual users apart from the number of vehicles assigned to corporations (step S202). When the use permission unit 23 of the server 2 determines YES (step S202: YES), the use permission unit 23 of the server 2 sends a use permission notification to the information terminal 3 (step S203). The operation is thus completed.

In contrast, when the use permission unit 23 of the server 2 determines NO in step S202 (step S202: NO), the use permission unit 23 of the server 2 sends a use non-permission notification to the information terminal 3 (step S204). The operation is thus completed.

As described above, according to the embodiment of the vehicle management system 100, the server 2 can permit corporate users to use vehicles available for car sharing services at least within the predetermined number of vehicles assigned to corporations for the predetermined day of the week and time range, and the server 2 can permit the individual users to use the number of vehicles excluding the number of vehicles assigned to corporations from a total number of vehicles available for the car sharing services.

This can promote use of vehicles by corporations by setting the number of vehicles assigned to corporations during the day of the week and the time range in which use by individual users is not expected, which leads to an increase in the number of vehicles used.

Furthermore, in the vehicle management system 100 according to the embodiment, the server 2 calculates transitions in the number of non-operating vehicles that are not used by the users for each predetermined rental area based on the use record information of the individual users. The server 2 creates groups of the days of the week and of the time ranges where the transition trends of the number of non-operating vehicles are similar to each other for the rental area based on the calculated transitions in the number of non-operating vehicles, and sets the assigned number of vehicles based on the transitions in the number of non-operating vehicles for the grouped days of the week and the grouped time ranges.

This allows setting the number of vehicles assigned to corporations based on the use status of the individual users that changes depending on the day of the week and the time range, which makes it possible to maintain a high level of a vehicle operation rate.

Thus, the vehicle management system 100 according to the embodiment can improve the use rate of the vehicles available for the car sharing services.

### Modification

The present disclosure is not limited to the embodiment described above and can be implemented in various other forms without departing from the scope of the present disclosure. Accordingly, the embodiment described above is merely illustrative in all respects and is not to be construed as restrictive. For example, the respective processing steps described above can be changed as desired in order or executed in parallel as long as there is no inconsistency in processing content.

The components of the corporate terminal 1, the server 2, and the information terminal 3 are not limited to the components of the embodiment described above and may be added appropriately as necessary.

What is claimed is:

1. A vehicle management device comprising:
a processor configured to permit a first user belonging to a first user group to use a vehicle available for car sharing services within a range of an assigned number of vehicles preferentially assigned to the first user group that is able to be set in advance at least for a predetermined day of a week and a predetermined time range, and permit a second user belonging to a second user group to use a remaining number of vehicles excluding the assigned number of vehicles from a total number of vehicles available for the car sharing services.

2. The vehicle management device according to claim 1, wherein the processor is configured to:
calculate for a predetermined rental area, based on vehicle use record information of the second user, a transition in a number of non-operating vehicles which are vehicles not used;
create groups of the days of the week and of the time ranges where transition trends in the number of non-operating vehicles are similar to each other for the rental area based on the calculated transition in the number of non-operating vehicles; and
set the assigned number of vehicles based on the transition in the number of non-operating vehicles for the grouped days of the week and the grouped time ranges.

3. The vehicle management device according to claim 2, wherein the processor is configured to set a smallest number of vehicles, out of the number of non-operating vehicles transitioning in combination of the grouped days of the week and the grouped time ranges, as the assigned number of vehicles.

4. The vehicle management device according to claim 2, wherein the first user group is a corporation and the processor is configured to divide the assigned number of vehicles and set the divided number of vehicles for each corporation when there is a plurality of corporations.

5. The vehicle management device according to claim 2, wherein the processor is configured to further set a discount rate of a use fee for the first group, and the discount rate is set to increase as a rate of the number of non-operating vehicles with respect to the total number of vehicles increases.

6. The vehicle management device according to claim 1, wherein the processor is configured to permit the first user to use an extra number of vehicles exceeding the assigned number of vehicles, the extra number of vehicles being within a range of the number of vehicles that is allowed to be used by the second user.

7. A vehicle management method executed by a processor, the vehicle management method comprising:
permitting a first user belonging to a first user group to use a vehicle available for car sharing services within a range of an assigned number of vehicles preferentially assigned to the first user group that is set in advance at least for a predetermined day of a week and time range, and permitting a second user belonging to a second user group to use a remaining number of vehicles excluding the assigned number of vehicles from a total number of vehicles available for the car sharing services.
